(19) United States
(12) Patent Application Publication
(10) Pub. No.: US 2005/0135038 A1
(43) Pub. Date: Jun. 23, 2005

(54) Quick release low-profile AC input filter

(76) Inventor: Matthew M. Moore, Columbia, SC (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/744,196

(22) Filed: Dec. 22, 2003

(51) Int. Cl. H02H 9/06

(52) U.S. Cl. 361/118

(57) ABSTRACT

Methods and associated apparatus of providing a low profile, quick disconnect AC filter are described. Those methods comprise providing a low profile AC filter that is attached within a housing at a first position, pivoting the AC filter to a second position by applying a first force to a power cable connected to the AC filter in a direction away from the housing, and removing the power cable from the AC filter by applying a second force to the power cable, wherein the AC filter is returned to the first position.

### FIELD OF THE INVENTION

The present invention relates to the field of power filters, and more particularly to methods of providing a quick disconnect, low profile AC power filter and its associated structures.

### BACK GROUND OF THE INVENTION

Alternating current (AC) power filters are commonly used to filter noise, for example, when connected to an AC power source. An AC power filter may receive AC power from a power cord, as is well known in the art, and may then deliver filtered AC power to a system, such as a computing system. One desired feature of an AC power filter is that it should be capable of quickly disconnecting power to the system as needed, for example, in order to prevent damage to the system. Another desired feature of an AC power filter is that it should posses a low profile within the housing or chassis, within which it resides, in order to conserve space within the system. The present invention provides such a low profile, quick disconnect AC power filter.

### BRIEF DESCRIPTION OF THE DRAWINGS

While the specification concludes with claims particularly pointing out and distinctly claiming that which is regarded as the present invention, the advantages of this invention can be more readily ascertained from the following description of the invention when read in conjunction with the accompanying drawings in which:

FIGS. 1a-1e represent structures according to an embodiment of the present invention.

FIGS. 2a-2h represent structures according to an embodiment of the present invention.

FIG. 3 represents a flowchart of a method according to an embodiment of the present invention.

FIG. 4 represents a flowchart of a method according to an embodiment of the present invention.

FIG. 5 represents a system according to an embodiment of the present invention.

### DETAILED DESCRIPTION OF THE PRESENT INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein, in connection with one embodiment, may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

Methods and associated apparatus of a quick disconnect low profile AC filter are described. Those methods comprise providing an AC filter that is attached within a housing at a first position, and then pivoting the AC filter to a second position by applying a first force to a power cable connected to the AC filter in a direction that is away from the housing. The AC power filter may then be quickly disconnected by applying a second force to the input power cable in a direction away from the housing.

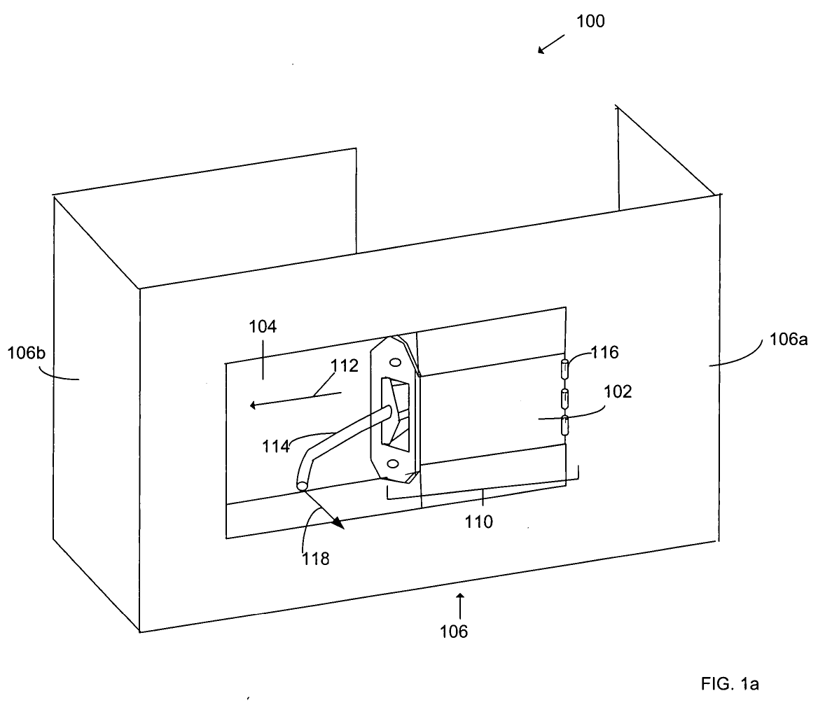

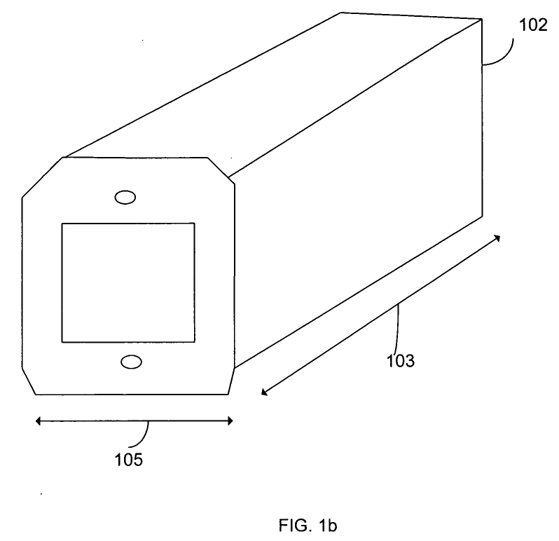

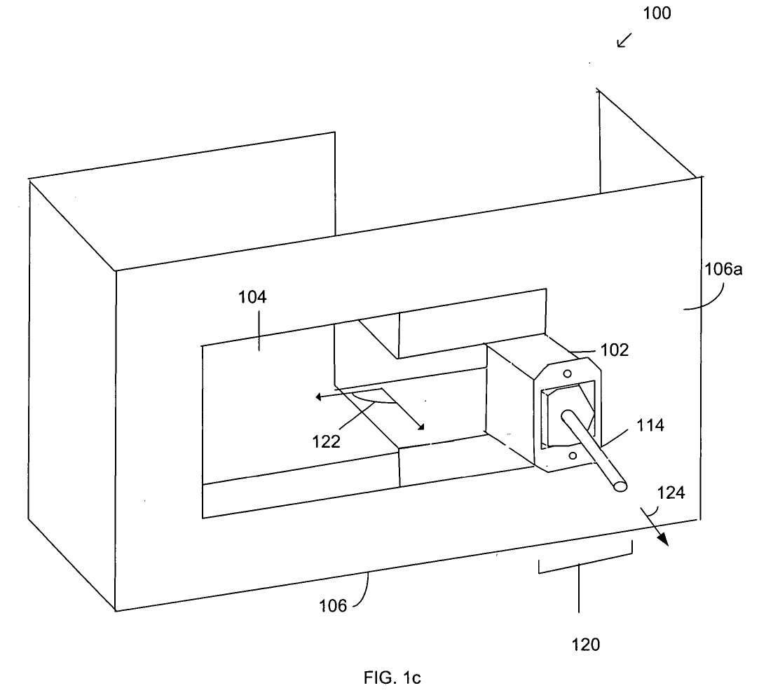

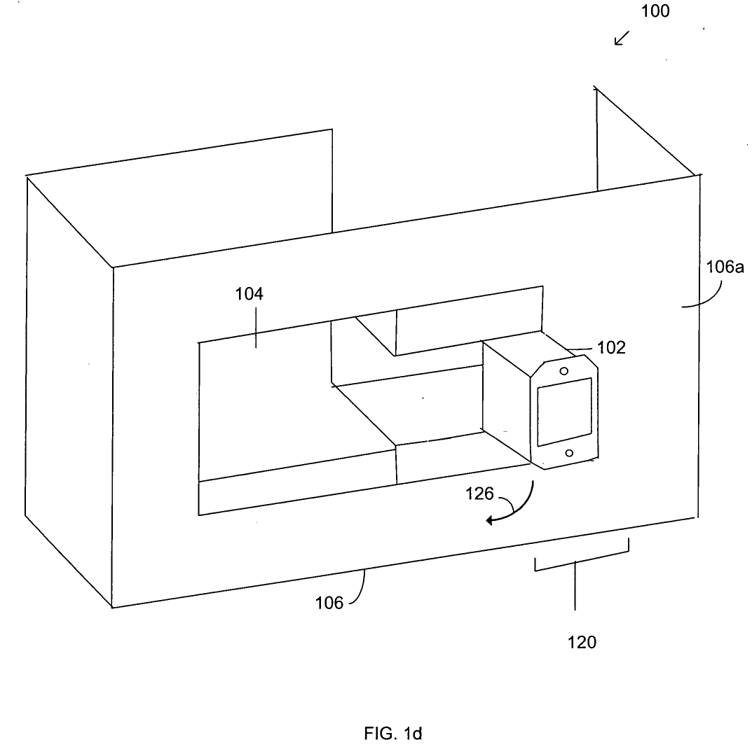

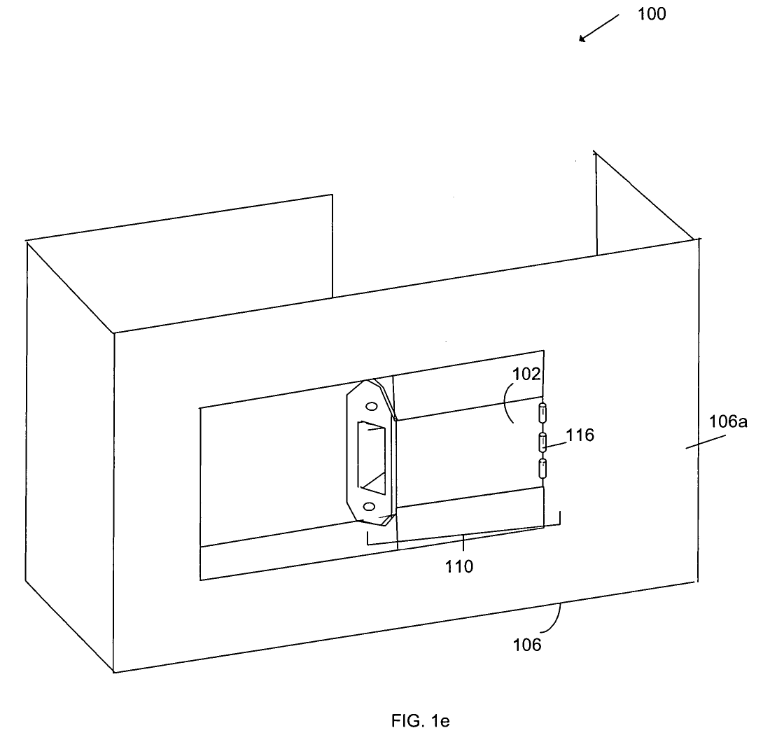

FIGS. 1a-1d illustrate an embodiment of a method and associated structures of quickly disconnecting a low profile AC filter from a power source according to the present invention. FIG. 1a illustrates a portion of a power subassembly 100 that may comprise an AC filter 102, as is well known in the art, which may be attached within a recess 104 of a housing 106, although it will be appreciated by those skilled in the art that the AC filter 102 may reside in other locations within the housing 106, depending upon the particular application. The housing 106 may comprise a front surface 106a, and a side surface 106b.

The power subassembly 100 may reside within a chassis, as is well known in the art, (not shown) which in turn may comprise various other components, such as at least one computing device (not shown). The AC 102 filter may reside in a first position 110 within the recess 104 of the housing 106. The first position 110 of the AC filter 102 may comprise an angle 112 that may comprise about zero degrees, that is, the AC filter 102 may be substantially parallel in relation to the first surface 106a of the housing 106.

The AC filter 102 may comprise a power cord 114, which may supply AC power from a power source (not shown), such as an electrical outlet, as is well known in the art. The AC filter 102 may be attached to the housing 106 with a pivoting mechanism 116, which may be any type of device that allows for the pivoting of the AC filter 102 outwards in a direction away from the housing 106. It will be understood by those skilled in the art that the particular configuration of the AC filter 102 and the pivoting mechanism 116 within the housing 106 may vary depending upon the particular design application.

FIG. 1b shows a portion of the AC filter 102 that depicts the dimensions of the AC filter 102 of the present invention. The AC filter 102 may preferably be a low profile AC filter 102, that is, the ratio of the width 105 to the length 103 of the AC filter 102 may preferably be greater than about 1:1, and is more preferably greater than about 2:1.

Referring back to FIG. 1a, a first force 118, which may be a force that is preferably in a substantially perpendicular direction to the housing 106, may be applied to the power cord 114. A sufficient amount of the first force 118 may be applied to the power cord 114 such that the AC filter 102 may pivot in a direction away from the housing 106. It will be understood by those skilled in the art that the amount and direction of the first force 118 that is sufficient to enable the pivoting of the AC filter 102 may vary depending upon the particular application.

FIG. 1c depicts the AC filter 102 after a sufficient amount of the first force 118 has been applied to the power cord 114 (in a direction away from the housing 106) to cause the AC filter 102 to pivot from the first position 110 to a second position 120. The second position 120 may comprise an angle 122 that may be between about 20 degrees and about 120 degrees, but is preferably about 90 degrees i.e. the second position 120 of the AC filter 102 may be preferably be substantially perpendicular to the housing 106.

A second force 124 may then further be applied to the power cord 114 in a direction away from the housing which may cause the power cord 114 to be removed, or disconnected, from the AC filter 102, as shown in FIG. 1d. The amount of the second force 124 is preferably such that the power cord 114 is capable of quickly disconnecting from the AC filter 102. The ability of the AC filter 102 of the present invention to quickly disconnect form a power cord is advantageous in cases where quick disconnection is required in order to avoid electrical damage to a system, for example. It will be understood that the second force 124 and the first force 118 may comprise one single force, i.e. the force to necessary to pivot the AC filter 102 from the first position 110 to the second position 120 may comprise a single continuous force.

Thus, the present invention enables the disconnection of a power cord, such as the power cord 114, from an AC filter (such as the AC filter 102), in a quick and efficient manner, through the application of a sufficient amount of the second force 124 on the power cord 114 attached to the AC filter 102. The AC filter design of the present invention also enables the use of a low profile AC filter that fits inside the housing of a power subassembly to optimize space utilization within a system, such as a networking and/or telecom networking server system.

As shown in FIG. 1e, sufficient amount of third force 126 may be applied to the AC filter 102 in a direction towards the housing to return the AC filter to the first position 110 (see FIG. 1e). It will be appreciated that the first force 118, the second force 124 and the third force 126 may be applied by a human operator, or may be supplied by other means, such as electrical or mechanical means as are well known in the art.

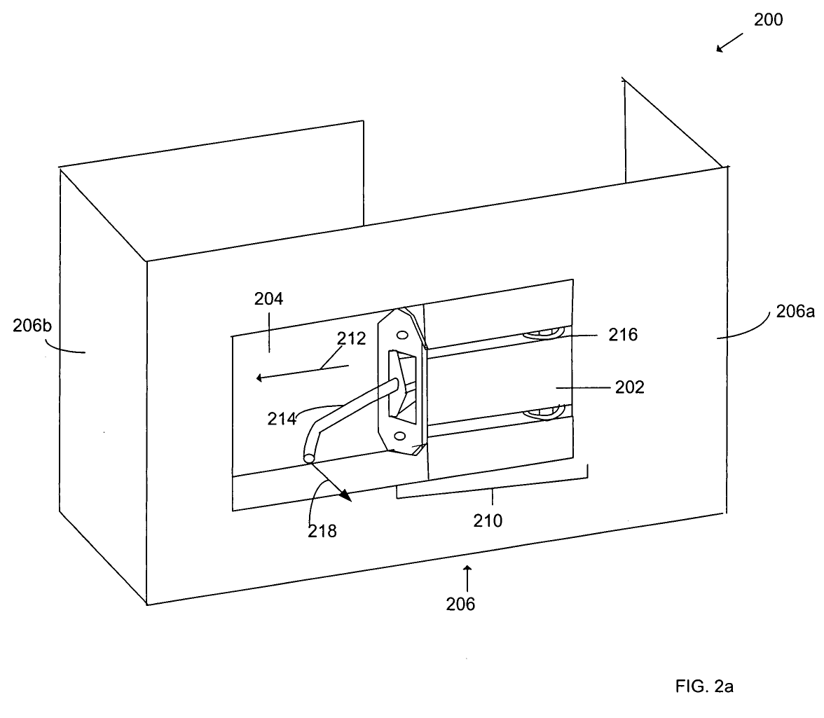

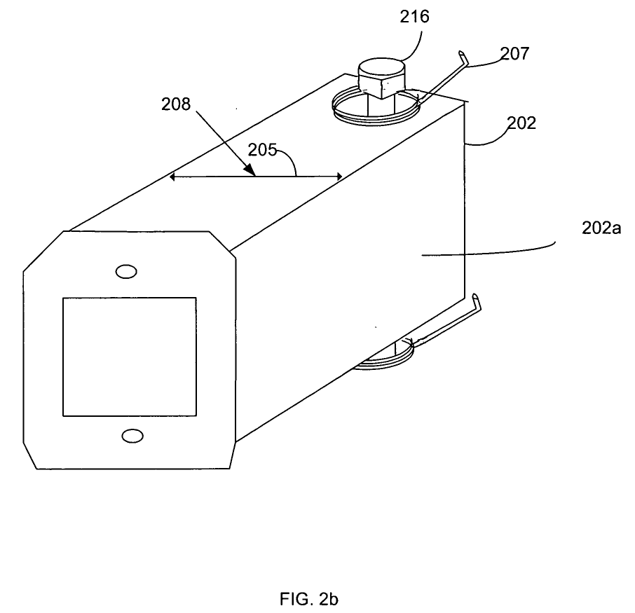

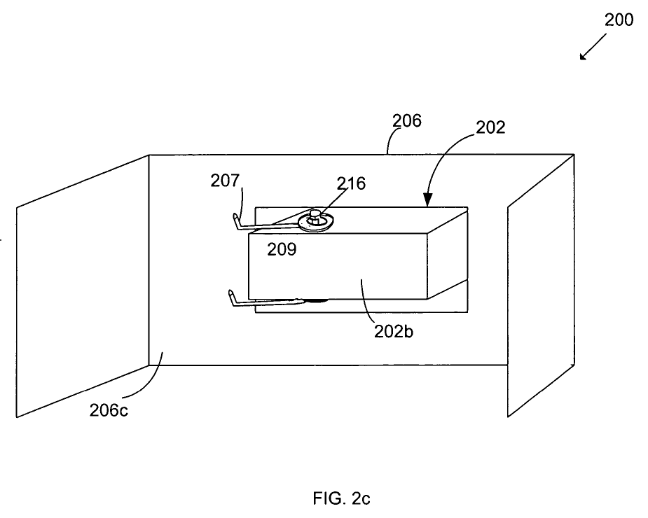

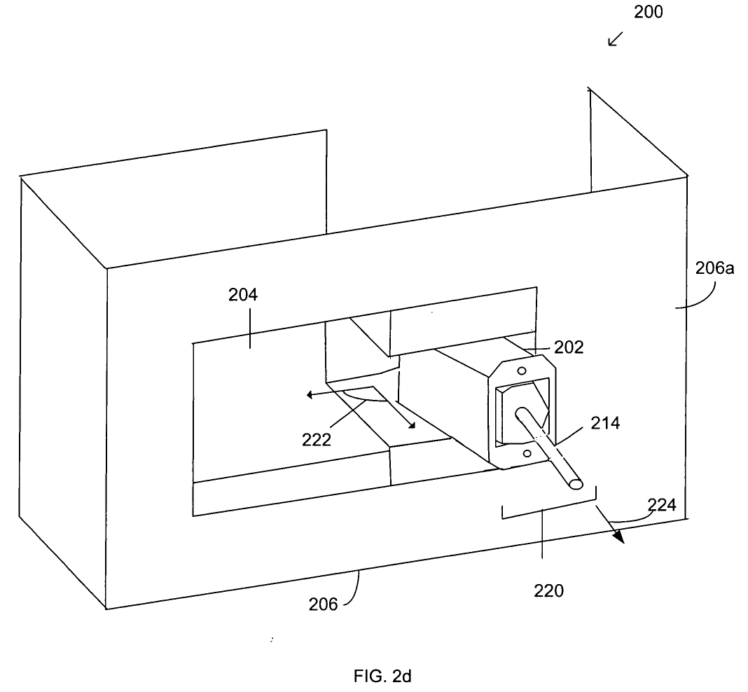

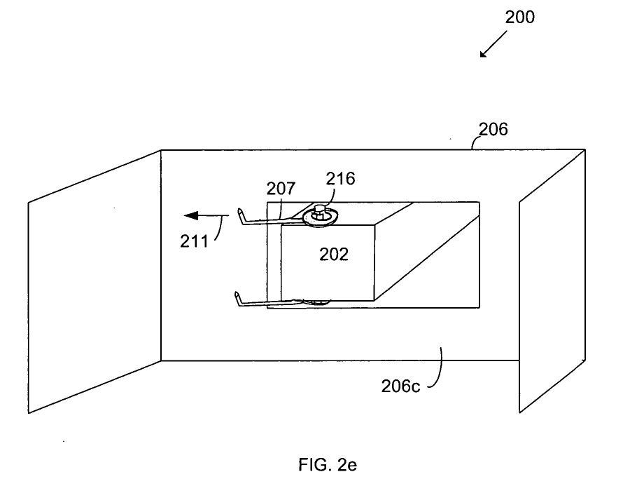

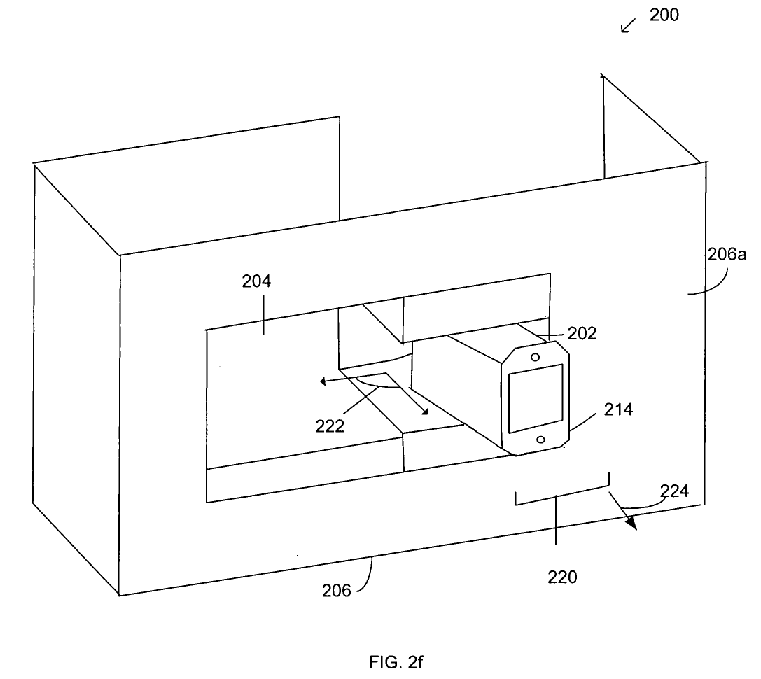

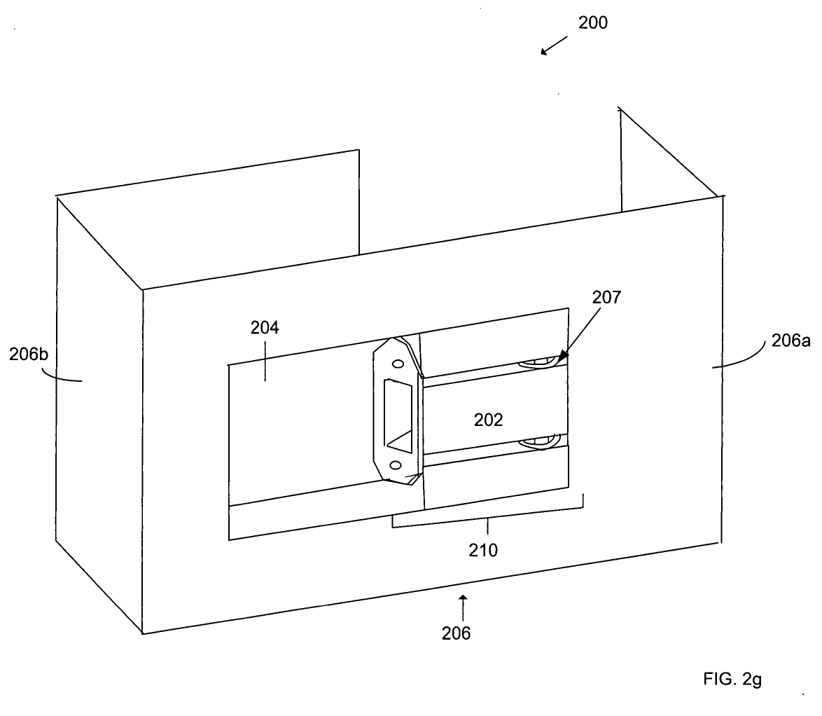

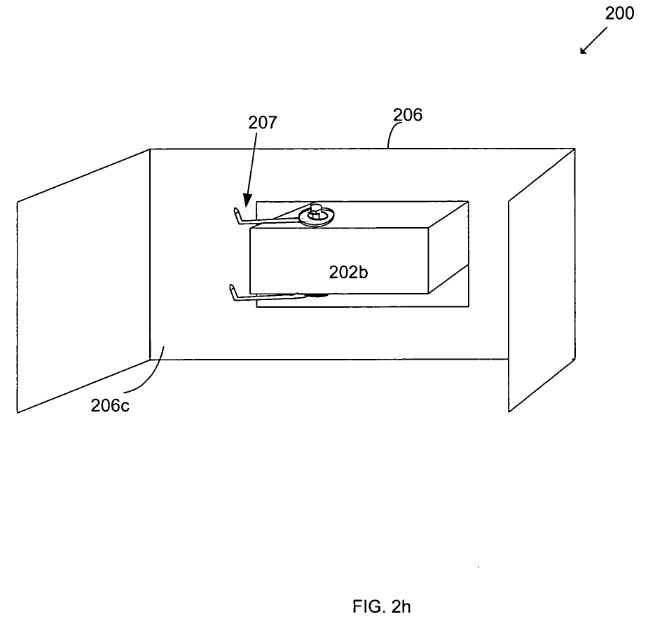

FIGS. 2a-2h depict another embodiment of the present invention. FIG. 2a illustrates a portion of a power subassembly 200, (similar to the power subassembly 100 of FIG. 1a) that may comprise an AC filter 202, which may be attached within a housing 206. The housing 206 may comprise a front surface 206a, and a side surface 206b. The power subassembly 200 may reside within a chassis (not shown), as is well known in the art.

The AC filter 202 may reside in a first position 210 within the recess 204 of the housing 206, although it will be appreciated by those skilled in the art that the AC filter 202 may reside in other locations within the housing 106, depending upon the particular application. The first position 210 of the AC filter 202 may comprise an angle 212 that may comprise about zero degrees, that is, the AC filter 202 may be substantially parallel in relation to the first surface 206a of the housing 206.

The AC filter 202 may comprise a power cord 214, similar to the power cord 114 of FIG. 1a. The AC filter 202 may be attached to the housing 206 with a pivoting mechanism 216, such as a pivot screw, as is known in the art, which may function to pivot the AC filter 202 so that the AC filter 202 is capable of pivoting away from the housing 206 (see FIG. 2b). The pivoting mechanism 216 may comprise a returning mechanism 207, which may comprise a torsion spring, as is known in the art.

It will be understood by those skilled in the art that the particular configuration of the AC filter 202 and the pivoting mechanism 216 within the housing 206 may vary depending upon the particular design application, but in the current embodiment, the pivoting mechanism 216 is located near the center 208 of the width 205 of the AC filter 202. For example, the pivoting mechanism may be located closer to a front side 202a of the AC filter 202, or it may be located closer to a backside 202b (see FIG. 2c) of the AC filter 202, depending upon the application.

FIG. 2c depicts a back side 206c of the housing 206. The returning mechanism 207 may be attached to the AC filter 202 and to the housing 206. In the current embodiment, the returning mechanism 207 may comprise a torsion spring, for example, which may elongate, or be stretched to create a tension 211 in the torsion spring (see FIG. 2e) upon pivoting the AC filter 202 from the first position 210 to a second position 220 (as shown in FIG. 2c) in a manner well known in the art. However, the returning mechanism 207 may include any such mechanism that functions to return the AC filter 202 from the second position 220 (as shown in FIG. 2c) to the first position 210 (FIG. 2a). It will be understood by those skilled in the art that the particular configuration of the AC filter 202 and the returning mechanism 207 within the housing 206 may vary depending upon the particular design application.

Referring back to FIG. 2a, a first force 218, similar to the first force 118, may be applied to the power cord 214. A sufficient amount of the first force 218 may be applied to the power cord 214 in a direction away from the housing 206 such that the AC filter 202 may pivot in a direction away from the housing 206 (see FIG. 2d) to a second position 220. When the AC filter 202 is pivoted to the second position 220 upon the application of the first force 218 to the power cord 214, the tension 211 may be induced in the returning mechanism 207 (FIG. 2e).

Referring back to FIG. 2d, a second force 224 may then further be applied in a direction away from the housing to the power cord 214 which may cause the power cord 214 to be removed, or disconnected, from the AC filter 202 (see FIG. 2f). The amount of the second force 224 may be such that the power cord 214 may be quickly removed from the AC filter 202.

After the power cord 214 is caused to be disconnected from the AC filter 202 by the application of the second force 224, the tension 211 on the returning mechanism 207 may then be removed, as is known in the art. As the tension 211 is removed from the returning mechanism 207, the returning mechanism 207 may then induce the AC filter 202 to return to the first position 210 (FIGS. 2g and 2h).

Thus, the current embodiment of the present invention enables the quick disconnection of an AC filter from a power source. In addition, because the AC filter comprises a low profile, space utilization within the system, may be greatly enhanced.

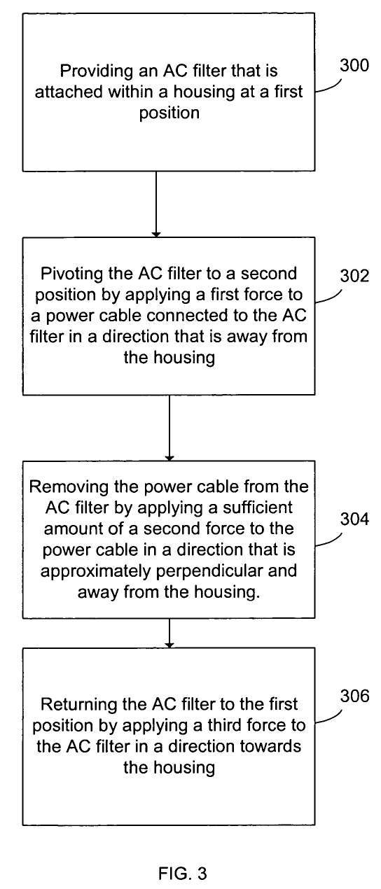

FIG. 3 depicts a flow chart of a method according to an embodiment of the present invention. At step 300, an AC filter is provided that is attached within a housing at a first position. At step 302, the AC filter is pivoted to a second position by applying a first force to a power cable connected to the AC filter in a direction that is away from the housing. At step 304, the power cable is removed from the AC filter by applying a sufficient amount of a second force to the power cable in a direction that is approximately perpendicular and away from the housing. At step 306, the AC filter is returned to the first position by applying a third force to the AC filter in a direction towards the housing.

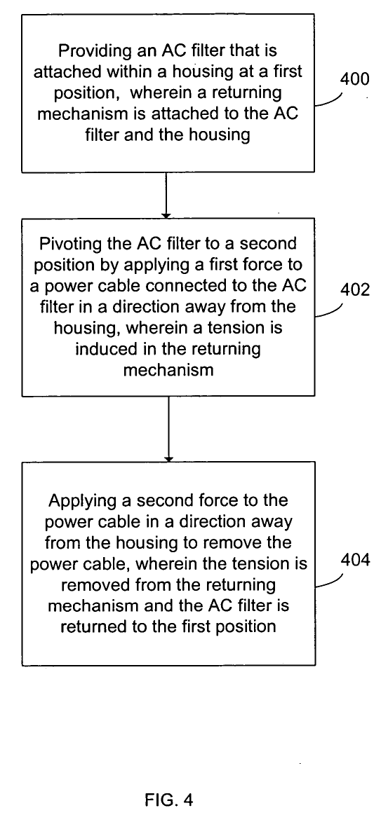

FIG. 4 depicts a flow chart of a method according to another embodiment of the present invention. At step 400, an AC filter is provided that is attached within a housing at a first position, wherein a returning mechanism is attached to the AC filter and to the housing. At step 402, the AC filter is pivoted to a second position by applying a first force to a power cable connected to the AC filter in a direction away from the housing, wherein a tension is induced in the returning mechanism. At step 404, a second force is applied to the power cable in a direction away from the housing to remove the power cable, wherein the tension is removed from the returning mechanism and the AC filter is returned to the first position.

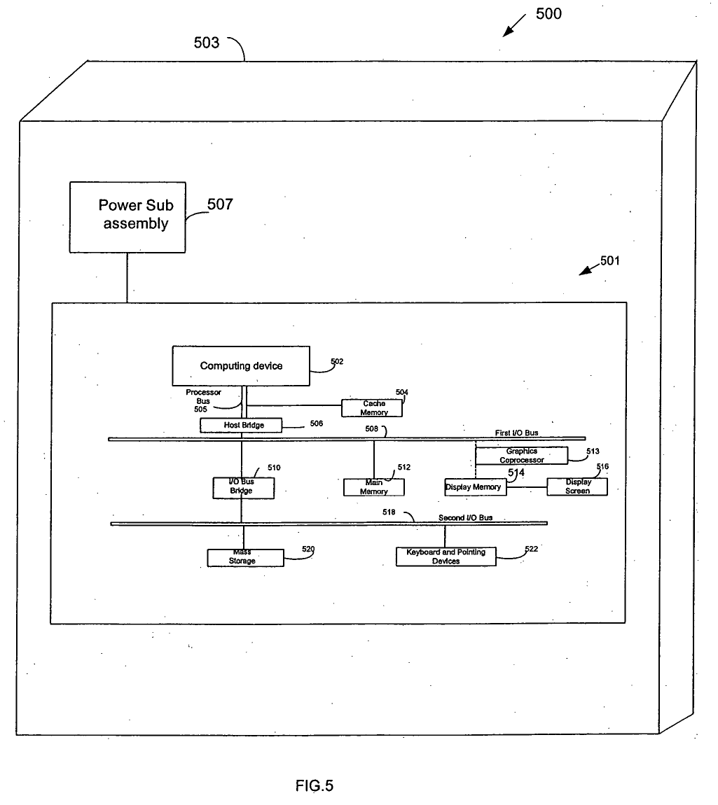

FIG. 5 depicts a system according to an embodiment of the present invention. The system 500 may include a computing system 501 that may include a computing device 502, such as a microprocessor, that may be attached within a chassis 503. The computing system 502 may comprise various other components, such as a cache memory 504 a processor bus 505, a first I/O bus 508 and second I/O bus 518, a host bridge 506, a main memory 512 a display memory 514 and a display screen 516, as well as a mass storage 520, and keyboard and pointing devices 522. The computing system 501 may be coupled, or attached to the chassis 503 in a manner well known in the art.

The system 500 may also comprise a power subassembly 507, such as the power subassemblies 100 and 200, coupled to the computing system 501 and attached to the chassis 503. The system 500 may comprise but is not limited to a computer networking system, a server system, a work-station or a desktop.

As described above, the present invention provides methods and associated apparatus of providing a low profile, quickly releasing AC filter within a system, such as a computing system. The methods and structures of the present invention enable the quick, safe disconnection of the AC filter from such systems as a computer networking system, a server system, a work station or a desktop computer. The low profile AC filter optimizes the usage of space within such a system.

Although the foregoing description has specified certain steps and materials that may be used in the method of the present invention, those skilled in the art will appreciate that many modifications and substitutions may be made. Accordingly, it is intended that all such modifications, alterations, substitutions and additions be considered to fall within the spirit and scope of the invention as defined by the appended claims. In addition, it is appreciated that a power subassembly, such as may be found in a computing system, is well known in the art. Therefore, it is appreciated that the Figures provided herein illustrate only portions of an exemplary power subassembly that pertains to the practice of the present invention. Thus the present invention is not limited to the structures described herein.

1. A method comprising:
providing an AC filter that is attached within a housing at a first position; and
pivoting the AC filter to a second position by applying a sufficient amount of a first force to a power cable connected to the AC filter in a direction that is away from the housing.

2. The method of claim 1 further comprising removing the power cable from the AC filter by applying a sufficient amount of a second force to the power cable in a direction that is approximately perpendicular and away from the housing.

3. The method of claim 1 wherein pivoting the AC filter to a second position by applying a sufficient amount of a first force comprises pivoting the AC filter to a second position and removing the power cable connected to the AC filter by applying a sufficient amount of a force.

4. The method of claim 2 further comprising returning the AC filter to the first position by applying a sufficient amount of a third force to the AC filter in a direction towards the housing.

5. The method of claim 1 wherein pivoting the AC filter to a second position comprises pivoting the AC filter to an angle that is between about 20 degrees to about 120 degrees.

6. The method of claim 1 wherein providing an AC filter that is attached within a housing at a first position comprises providing an AC filter that is attached within a housing at a first position, wherein the ratio of the width of the AC filter to the length of the AC filter is greater than about 1:1.

7. A method comprising:
providing an AC filter that is attached within a housing at a first position, wherein a returning mechanism is attached to the AC filter and to the housing;
pivoting the AC filter to a second position by applying a sufficient amount of a first force to a power cable connected to the AC filter in a direction away from the housing, wherein a tension is induced in the returning mechanism; and
applying a sufficient amount of a second force to the power cable in a direction away from the housing to remove the power cable, wherein the tension is removed from the returning mechanism and the AC filter is returned to the first position.

8. The method of claim 7 wherein providing an AC filter that is attached within a housing at a first position, wherein a returning mechanism is attached to the AC filter and to the housing comprises providing an AC filter that is attached within a housing at a first position, wherein a torsion spring is attached to the AC filter and to the housing.

9. The method of claim 7 wherein applying a sufficient amount of a second force to the power cable in a direction away from the housing to remove the power cable, wherein the tension is removed from the returning mechanism and the AC filter is returned to the first position comprises removing the power cable, wherein the tension is removed from the returning mechanism and the AC filter is returned to the first position.

10. The method of claim 7 wherein pivoting the AC filter to a second position comprises pivoting the AC filter to an angle that is between about 20 degrees and about 120 degrees.

11. An AC filter comprising:
an AC filter that is attached within a housing at a first position, wherein the AC filter is capable of pivoting to a second position.

12. The AC filter of claim 11 further comprising a power cable that is connected to the AC filter, wherein the power cable is capable of disconnecting from the AC filter when a sufficient amount of a force is applied to the power cable in a direction away from the housing.

13. The AC filter of claim 11 further comprising a returning mechanism that is attached to the AC filter and to the housing that is capable of returning the AC filter from the second position to the first position.

14. The AC filter of claim 13 wherein the returning mechanism comprises a torsion spring.

15. The AC filter of claim 11 wherein the ratio of the width of the AC filter to the length of the AC filter is greater than about 1:1.

16. A system comprising:
a chassis;
a computing system attached to the chassis;
a power subassembly coupled to the computing system comprising a housing that is attached to the chassis; and
an AC filter that is attached within the housing at a first position, wherein the AC filter is capable of pivoting to a second position.

17. The system of claim 16 wherein the computing system comprises a microprocessor.

18. The system of claim 16 wherein the system comprises at least one of a workstation, a server, and a desktop computer.

19. The system of claim 16 wherein the ratio of the width of the AC filter to the length of the AC filter is greater than about 1:1.

20. The system of claim 16 further comprising a returning mechanism that is attached to the AC filter and to the housing that is capable of returning the AC filter from the second position to the first position.

21. The system of claim 16 wherein the AC filter further comprises a power cable that is connected to the AC filter, wherein the power cable is capable of disconnecting from the AC filter when a sufficient amount of force is applied to the power cable in a direction away from the housing.
